(19) United States
(12) Patent Application Publication
(10) Pub. No.: US 2012/0131368 A1
(43) Pub. Date: May 24, 2012

(54) ELECTRONIC DEVICE AND POWER SAVING METHOD THEREOF

(75) Inventors: YU-LIANG YANG, Shenzhen City (CN); HSIEN-CHUNG SHIH, Tu-Cheng (TW); YAN-XIANG HUANG, Shenzhen City (CN); SHA-SHA HU, Shenzhen City (CN); BO-CHING LIN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/083,585

(22) Filed: Apr. 10, 2011

(30) Foreign Application Priority Data
Nov. 23, 2010 (CN) 201010555173.1

(51) Int. Cl. G06F 3/048; G06F 1/32

(52) U.S. Cl. 713/323; 715/776

(57) ABSTRACT

An electronic device includes an input unit, a memory, a page flipping control unit, a buffer, a display, a processor and a switching unit. The input unit generates flipping commands in response to operations of a user. The memory stores a document. The processor displays the document in response to a document opening operation of the user, retrieves a predetermined page range of pages of the document from the memory, and stores the retrieved pages of the document in the buffer. The page flipping control unit receives the flipping commands, accesses the buffer, and flips pages on the display. The switching unit is connected to the memory, the display, and the buffer, and establishes a connection between the display, the buffer and the processor or establishes a connection between the display, the buffer, and the page flipping control unit under control of the processor.

### BACKGROUND

1. Technical Field

The present disclosure relates to an electronic device and a power saving method thereof.

2. Description of Related Art

For some electronic readers, the processor of a such electronic device controls the function components to store to-be-displayed contents in a Synchronous Dynamic Random Access Memory (SDRAM) when users are reading files on the electronic device. The processor retrieves the contents to display on the display in response to a signal for paging up/down triggered by the user. Thus, the processor is working all the time when the user are reading the file on the electronic device, which is a waste of electricity.

Therefore, what is needed is an electronic device and a power saving method thereof to alleviate the limitations described above.

### BRIEF DESCRIPTION OF THE DRAWINGS

The components in the drawings are not necessarily drawn to scale, the emphasis instead being placed upon clearly illustrating the principles of an electronic device and a power saving method thereof. Moreover, in the drawings, like reference numerals designate corresponding sections throughout the several views.

FIG. 1 is a block diagram of an electronic device in accordance with an exemplary embodiment.

FIG. 2 is a flowchart of a power saving method for the electronic device, such as the one of FIG. 1, in accordance with the exemplary embodiment.

FIG. 3 is a sub-flowchart of a method of a page flipping control unit executing paging up/down operations applied in the electronic device of FIG. 2.

### DETAILED DESCRIPTION

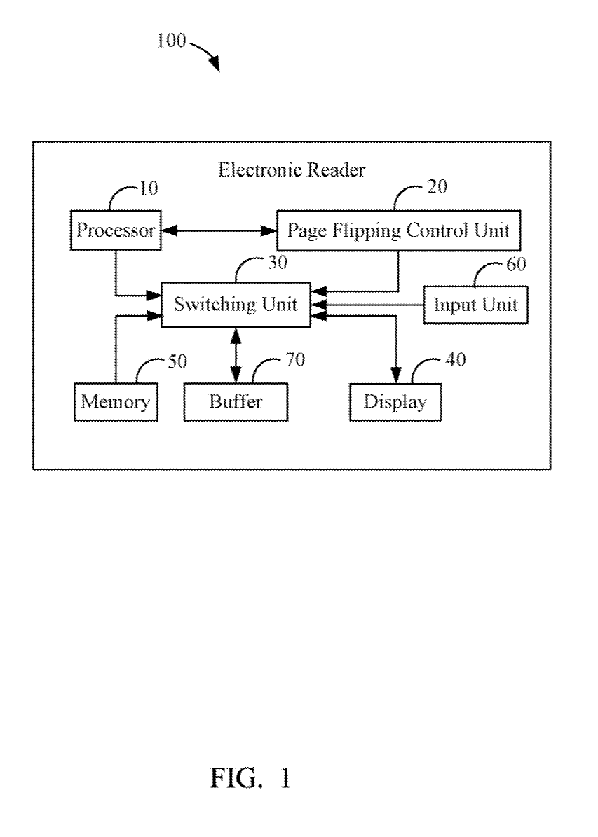

Referring to FIG. 1, an electronic device 100 is disclosed as an exemplary embodiment. The electronic device 100 includes a processor 10, a page flipping control unit 20, a switching unit 30, an electronic paper display 40, a memory 50, an input unit 60 and a buffer 70. In this embodiment, the electronic device 100 is an electronic reader, and the input unit 60 is configured for generating input signals in response to the operations of a user. The buffer 70 is an SDRAM. The memory 50 stores a number of documents which can be displayed on the display 40 of the electronic device 100. When the electronic device 100 enters a reading mode in response to the user inputs to open a document, the processor 10 retrieves a predetermined range of pages of the document from the memory 50, stores the retrieved pages in the buffer 70, and transmits a trigger signal to the page flipping control unit 20. Afterwards, the processor 10 enters a sleep mode. The page flipping control unit 20 controls the display 40 to page up/down and updates the contents on the display 40 with the pages stored in the buffer 70, thus performing the function of the processor 10 to page up/down for the electronic device 100 while the processor 10 remains in the sleep mode. Running of the processor 10 needs more power than needed for a page flipping process, therefore, use of the page flipping control unit 20, which can run on a low power consumption chip to do page flipping can reduce power consumption.

Both the processor 10 and the page flipping control unit 20 are electrically connected to the switching unit 30. The switching unit 30 connects the display 40, the memory 50, and the buffer 70. The switching unit 30 establishes a connection between the display 40, the buffer 70 and the processor 10 or establishes a connection between the display 40, the buffer 70, and the page flipping control unit 20.

Initially, the processor 10 establishes a connection between the display 40, the buffer 70, and the page flipping control unit 20 via the switching unit 30. The processor 10 responds to a user's manipulation to open a document and controls the display 40 to display the document. The processor 10 further pops up a dialog box configured for the user to select a predetermined range of pages for reading. For example, when the predetermined range of pages is from page N to page M, the processor 10 retrieves the contents from page N to page M of the document from the memory 50, and stores the contents from page N to page M of the document in the buffer 70. Then, the processor 10 transmits a first trigger signal to the page flipping control unit 20, and enters the sleep mode. In this embodiment, both numbers N and M are positive integers. In an alternative embodiment, both numbers N and M are predetermined and the user does not need to select them. In another embodiment, the processor 10 retrieves the whole document from the memory 50, and stores the whole document in the buffer 70.

The processor 10 further controls the switching unit 30 to enable the connection between the page flipping control unit 20 and both the display 40 and the buffer 70, and the processor 10 then enters a sleep mode.

The page flipping control unit 20 is configured for receiving the flipping commands from the input unit 60, accessing the buffer 70 and flipping pages on the display 40. The page flipping control unit 20 is further configured for transmitting a second trigger signal to the processor 10 to wake the processor 10, when users reach the last page or the last few pages of the contents stored in the buffer 70. For example, when the users reach page M−2, the page flipping control unit 20 transmits the second trigger signal to the processor 10 to wake the processor 10. The processor 10 controls the switching unit 30 to enable the connection with both of the display 40 and the buffer 70. The processor 10 retrieves a predetermined number of pages following the previously retrieved pages from the memory 50, and stores the retrieved pages in the buffer 70. The predetermined number is M−N. For example, the processor 10 retrieves page M+1 to page (M+1)+(M−N) of the document from the memory 50, and stores the retrieved pages in the buffer 70. After that the processor 10 transmits the first trigger signal to the page flipping control unit 20, and enters the sleep mode again.

With such configuration, the page flipping control unit 20 takes the place of the processor 10 in the page up/down process, so that the processor 10 can enter the sleep mode. Without need to always keep the processor 10 working and further due to the page flipping control unit 20 uses much less power than the processor 10, therefore power consumption of the electronic device 100 is effectively reduced.

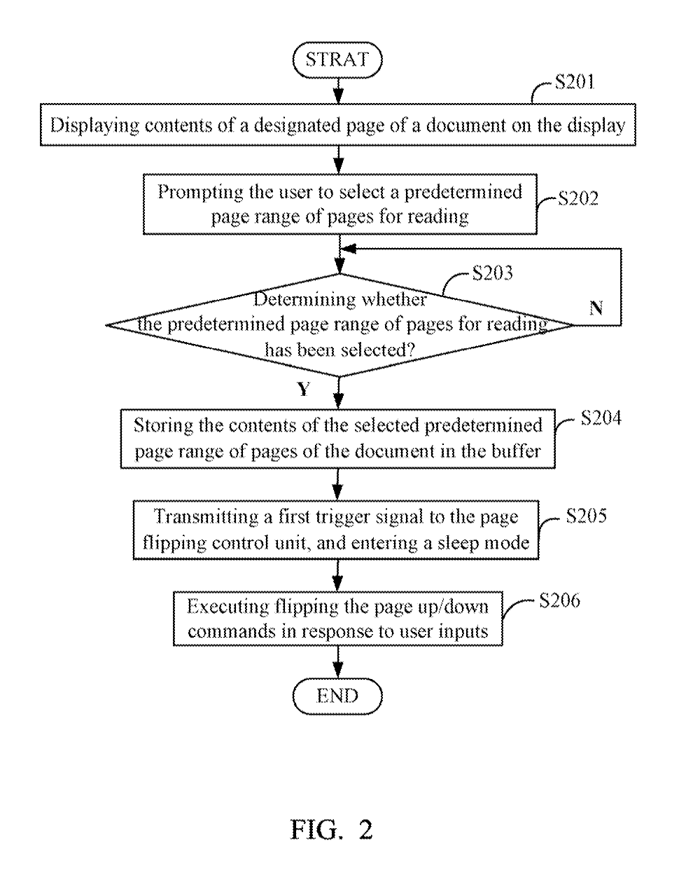

Referring to FIG. 2, a flowchart of a power saving method of the electronic device 100 is shown. The method includes the following steps, each of which are tied to various components contained in the electronic device 100 as shown in FIG. 1. In this embodiment, the processor 10 executes step S201 to S205, and the step S206 is executed by the page flipping control unit 20.

In step S201, displaying contents of a designated page of a document on the display 40. The designated page of the document is selected by the user via the input unit 60.

In step S202, prompting the user to select a predetermined page range of pages for reading. In this embodiment, a dialog box is popped up to prompt the user to select a start value and an end value of the page range. For example, M is selected as the start value of the page range, and N is selected as the end value of the page range. Both numbers N and M are positive integers. In an alternative embodiment, the page ranges from N to M is predetermined and default for the user by the process of the electronic device 100.

In step S203, determining whether the predetermined page range of pages for reading has been selected, if yes, the process goes to step S204, otherwise, the process goes back to step S202.

In step S204, storing the contents of the selected predetermined page range of pages of the document in the buffer 70. In this embodiment, initially, the processor 10 retrieves page N to page M of the document from the memory 50, and stores page N to page M of the document in the buffer 70. When the processor 10 has been waked up, the processor 10 retrieves a predetermined number of pages following the previously retrieved pages from the memory 50, and stores the retrieved pages in the buffer 70. For example, the processor 10 retrieves page M+1 to page (M+1)+(M−N) of the document from the memory 50, and stores the retrieved pages in the buffer 70.

In step S205, the processor 10 transmits a first trigger signal to the page flipping control unit 20, and enters a sleep mode.

In step S206, the page flipping control unit 20 executes flipping the page up/down commands in response to user inputs.

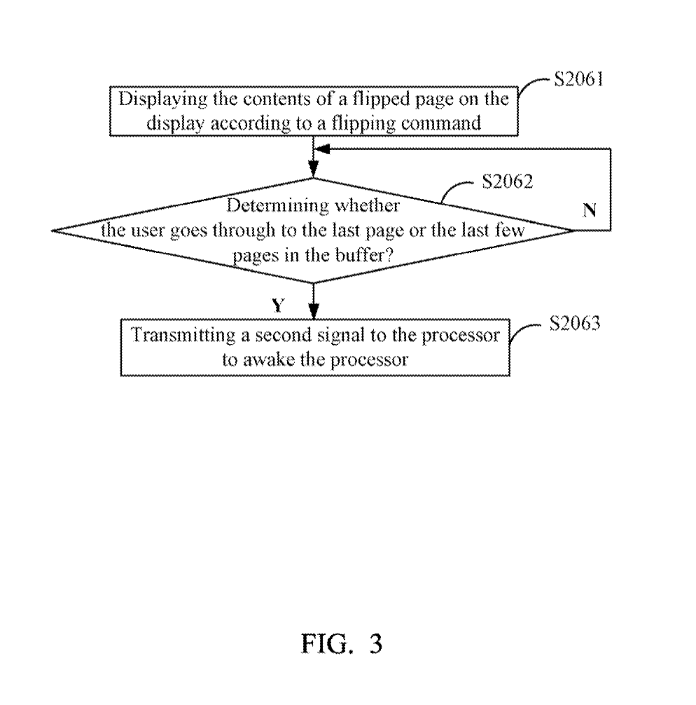

Referring to FIG. 3, a sub-flowchart of method of a page flipping control unit 20 for flipping the page up/down commands of FIG. 2 is shown. The step S206 includes the following steps.

In step S2061, displaying the contents of a flipped page on the display 40 according to a flipping command. In this embodiment, the input unit 60 in response to the user's operation generates the flipping command.

In step S2062, determining whether the user goes through to the last page or the last few pages in the buffer 70, if yes, repeating step S2062, otherwise, the process goes back to step S2061.

In step S2063, transmitting a second signal to the processor 10 to wake the processor 10, and then the process goes back to step S204.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device, comprising:
an input unit configured for generating flipping commands in response to operations of a user;
a memory to store a document;
a buffer;
a display;
a processor configured for displaying the document in response to a document opening operation of the user, retrieving a predetermined page range of pages of the document from the memory, and storing the retrieved pages of the document in the buffer;
a page flipping control unit configured for receiving the flipping commands, accessing the buffer and flipping pages on the display; and
a switching unit connected to the memory, the display and the buffer, and configured for establishing a connection between the display, the buffer and the processor or establishing a connection between the display, the buffer, and the page flipping control unit under control of the processor.

2. The electronic device as described in claim 1, wherein the processor enters a sleep mode when the page flipping control unit accesses the buffer to flip page on the display and wakes up when the page flipping control unit flips to the last page or the last few pages in the buffer.

3. The electronic device as described in claim 2, wherein the page flipping control unit is further configured for transmitting a trigger signal to wake the processor when it flips to the last page or the last few pages in the buffer.

4. The electronic device as described in claim 1, wherein the processor further pops up a dialog box to prompt the user to select the predetermined page range of pages of the document.

5. The electronic device as described in claim 4, wherein the processor is further configured for retrieving a predetermined number of pages following previously retrieved pages of the document from the memory after being waked up, and stores the retrieved pages in the buffer.

6. The electronic device as described in claim 1, wherein the electronic device is an electronic reader, and the display is an electronic paper display.

7. The electronic device as described in claim 1, wherein the buffer is a synchronous dynamic random access memory.

8. A power saving method for an electronic device, the electronic device comprising a display, a memory storing a document, a buffer, a processor and a page flipping control unit, the method comprising:
displaying contents of a designated page of the document on the display;
retrieving a number of pages following the designated page from the memory;
storing the number of pages in the buffer;
accessing the buffer by the page flipping control unit; and
executing flipping the page up/down commands by the page flipping control unit in response to user inputs.

9. The method as described in claim 8, wherein the processor falls asleep when the page flipping control unit accesses the buffer and updates contents on the display with the pages stored in the buffer.

10. The method as described in claim 9, wherein the steps of executing flipping the page up/down commands by the page flipping control unit in response to user inputs comprises the steps of:
updating contents by the page flipping control unit on the display with pages stored in the buffer; and
wakening the processor when the page flipping control unit flips to the last page or the last few pages.

11. The method as described in claim 10, further comprising the step of:
retrieving a number of pages by the processor following previously retrieved pages from the memory, and storing the retrieved pages in the buffer after the processor is waked up.

12. The method as described in claim 8, wherein the buffer is a synchronous dynamic random access memory.
